(19) United States
(12) Patent Application Publication
(10) Pub. No.: US 2013/0115384 A1
(43) Pub. Date: May 9, 2013

(54) CONTINUOUS METHOD FOR APPLYING A COVER OVER A METALLIC SHEET

(71) Applicant: Armando Sáenz-CHAPA, Monterrey (MX)

(72) Inventor: Armando Sáenz-CHAPA, Monterrey (MX)

(21) Appl. No.: 13/289,835

(22) Filed: Nov. 4, 2011

(51) Int. Cl. B05D 7/14; B05D 3/14; B05D 1/02; B05D 3/02

(52) U.S. Cl. 427/540; 427/318; 427/545; 427/543

(57) ABSTRACT

A continuous method for applying coatings to a metal, specifically a metal sheet roll, tape, or any metallic component, which comprises cleaning and heating the metal sheet to a preset temperature and then apply a coating of paint or varnish, which is quickly cured, as the soluble is evaporated by direct contact with hot metal.

### BACKGROUND OF THE INVENTION

A. Field of the Invention

The present invention is related to methods for applying coatings to metallic elements, and more particularly to a method for applying coatings to metallic elements such as metal rolls, metal sheets or any metallic element, wherein said method comprises preheating the metallic element to a preset temperature and applying the coating to the preheated metallic element under predefined application parameters.

B. Description of Related Art

Traditional methods for the application of coatings to a metallic element, normally comprise the application of said coatings o the metallic element and curing it at ambient temperature or by applying heat for reducing the curing time, by means of a drying area or tunnel.

Particularly, the application of coatings over metal sheet rolls is compacted, since the metal sheet can be wound only after curing the coating, thus making necessary to enlarge the curing line in order to process the greatest possible length of metal sheet in order to reduce the curing time. Furthermore it is necessary to wait for the metal sheet portion that is being cured, to be processed in order to process the remaining portion if the processing area is not large enough to process the whole length of the roll, so that the coating process cannot be performed continuously.

An example of such traditional method is described in U.S. Pat. No. 5,768,799, in which the sheet, after receiving the coating is heated by magnetic induction in a tunnel oven to evaporate the solvents and curing the coating.

Although the method described in U.S. Pat. No. 5,768,799 heats the metal sheet to accelerate the cure of the coating, it still requires a furnace having a considerable length to cure the major portion of sheet metal as possible, so that the speed at which the roll can be processed depends on the length of the furnace, which is critical for small industrial buildings.

In view of the disadvantages of the traditional methods described above, the Applicant developed a continuous method for applying a coating to metal sheets, which comprises cleaning and heating the metal sheet to a preset temperature and thereafter applying a coating, which is quickly cured, as the soluble is evaporated by direct contact with hot metal. Depending on the type of coating to be used, it may be necessary to use a vapor extraction system to remove them from the personnel operating the production line. The steel roll or tape can be preheated before bringing them into the production line or heated prior to coating.

By the method of the present invention, it is possible to continuously applying a coating to a metal sheet coming from a metal roll in a small area, because as the coating is cured almost instantaneously, the sheet can be rolled immediately, also reducing the cure time to a minimum.

Likewise, the method of the present invention can be used to coat metallic elements of any shape and size, and the coating works for any coating either epoxy paint, water-based paint, varnish dielectric.

### SUMMARY OF TE INVENTION

It is therefore a main object of the present invention to provide a continuous method for applying coatings to a metal, specifically a metal sheet roll, tape, or any metallic component, which comprises cleaning and heating the metal sheet to a preset temperature and then apply a coating of paint or varnish, which is quickly cured, as the soluble is evaporated by direct contact with hot metal.

It is still another object of the present invention, to provide a continuous method for applying coatings to a metal element of the above disclosed nature, wherein the metal sheet may be preheated, before bringing it into the production line or heated prior to coating.

It is another object of the present invention to provide a continuous method for applying coatings to a metal element of the nature described above, whereby it is possible to apply a coating to the sheet metal of a metal roll continuously, in a defined area, because as the coating is cured almost instantaneously, the sheet may be rolled almost immediately, also reducing the cure time to a minimum.

It is still a further object of the present invention to provide a continuous method for applying coatings to a metal element of the above disclosed nature, which can be used to coat metallic elements of any shape and size.

These and other objects and advantages of the continuous method for applying a coating to a metallic element of the present invention will become apparent to those persons having an ordinary skill in the art, from the following detailed description of the embodiments of the invention.

### DETAILED DESCRIPTION OF THE INVENTION

The method of the present invention will now be described in accordance with a preferred embodiment thereof, wherein the metal element to be coated comprises a steel roll and the coating comprises water-based paint, and wherein the method of the present invention comprising:
preheating a stainless steel sheet roll or an unrolled portion of the steel sheet to be coated at a temperature of between 40 to 90 degrees Celsius, preferably at 75° C. using one of the following methods: a) heating by rolls furnace, b) electrical resistance heating through physical contact of the metal and by resistance heaters, c) heating by means of an induction furnace by heating the entire roll of metal, d) heating by means of an electric arc, regulating the voltage to control the current passing through the metal;
passing the preheated metal sheet under one or more nozzles for spraying a coating comprising water-based paint, by a conveyor belt that moves the metal sheet at a speed of 10 to 400 ft/min, preferably at a speed of 100 ft/min, wherein the one or more nozzles generate a spray curtain of coating, regulating the flow of material to an amount of from 8 to 25 ml/sec. Optionally, if necessary, it can be used squeeze rolls or rakes to remove an excess of coating from the surface of the steel sheet, thereby regulating the thickness of the coating prior to winding the steel sheet with the cured coating;

The curing time after the coating contacts the preheated metal, is from 1 to 3 seconds depending on the amount of solute in kg per cubic meter of water containing the coating sprayed on the steel sheet.

Because the curing of the coating occurs almost immediately due to the almost immediate evaporation of the soluble, it is possible to roll the steel sheet while the steel roll is being processed, requiring therefore a processing space smaller than that required by traditional methods.

Preferably the steel roll is unwound and the entire length of the steel sheet is preheated in a continuous manner in a heater that preferably has a length of 5 meters, so that there may be portions of the metal sheet that are being preheated and others being sprayed with the coating.

In this embodiment, the production line preferably comprises, means for unwinding the roll of steel, a conveyor belt, which firstly passes through a radiant furnace having a length of 5 m and then under coating nozzles and finally means for rolling the steel sheet.

### EXAMPLES

A completely clean and rolled ASTM A1011 DS steel sheet, having a density of 7,850 kg/m2, a specific heat of 0.12 Btu/(kg-C), a thickness of 0.6 mm, an emissivity of steel (Eₚ) of 0.25 and an initial temperature of 30° C. is unrolled and placed on a conveyor belt.

The conveyor belt moves at a linear velocity of 100 ft/min and carries the steel sheet through a radiant furnace having a length of 5 meters and a width of 60 inches, wherein the radiants have an emissivity (Eₕ) of 0.85. The effective emissivity (E) of the funace is 0.2394 and the radiant temperature is 683.86° C. theoretical and 748.73° C. real.

The distance from the radiators to the steel sheet is inches and each portion of the steel sheet remained inside the furnace for a total time of 9.84 seconds, always moved by the conveyor, reaching a final temperature of 75° C. It was found that the heat required by the sheet to reach the final temperature was 6.98 watt/In² theoretical and 9.07 watt/In² real.

Once the steel sheet was preheated, it exited the radiant furnace and entered a chamber where the atomized paint was applied -paint diluted in water at a temperature of 50 degrees, of the type used for retarding the oxidation of steel—on the steel sheet by ten nozzles spraying paint in an amount of 10 ml/sec at 30 inches per side of the metal sheet. The drying time of the paint was 2 seconds, producing a layer of 0003″ of painting, which adhered to the surface of the steel sheet. The nozzles, work with three pressures: an activation pressure of 40 lbs/inch, which allows operation of a metering valve, a metering pressure regulated to 65 lb/inch for a translational speed of the steel sheet onto the conveyor belt of 65 feet/min at a flow rate of 15 ml/sec, and a working pressure which is used to extend the atomized paint curtain, set at 28 lb/in. Each nozzle is 4″ apart from the steel sheet and generates a curtain of 3.25″ wide. Because the paint dries two seconds after passing through the painting chamber, the steel sheet could be rolled immediately without the paint sticking to the roll.

Finally it must be understood that the continuous method for applying a coating to a metallic element of the present invention, is not limited exclusively to the embodiments above described and illustrated and that the persons having ordinary skill in the art can, with the teaching provided by the invention, to make modifications to the continuous method for applying a coating to a metallic element of the present invention, which will clearly be within of the true inventive concept and of the scope of the invention which is claimed in the following claims.

1. A method for applying a water based coating to a metallic element comprising:
preheating the metal element to a temperature of between 40 to 90° C.;
applying the coating on the metallic element so that when the coating contacts the preheated metal, the soluble is evaporated and the coating is cured.

2. A method for applying a coating according to claim 1, wherein the metallic element is preheated to a temperature of preferably 75° C.

3. A method for applying a coating according to claim 1, wherein the metallic element comprises a clean rolled stainless steel sheet which is preheated using one a method selected from the group comprising: a) heating by rolls furnace, b) electrical resistance heating through physical contact of the metal and by resistance heaters, c) heating by means of an induction furnace by heating the entire roll of metal, d) heating by means of an electric arc, regulating the voltage to control the current passing through the metal.

4. A method for applying a coating according to claim 1, wherein the preheated metal sheet is passed under one or more nozzles for spraying a coating comprising water-based paint, by a conveyor belt that moves the metal sheet at a speed of 10 to 400 ft/min, preferably at a speed of 100 ft/min, wherein the one or more nozzles generate a spray curtain of coating, regulating the flow of material to an amount of from 8 to 25 ml/sec.
